(19) United States
(12) Patent Application Publication
(10) Pub. No.: US 2023/0381765 A1
(43) Pub. Date: Nov. 30, 2023

(54) CATALYST SYSTEM FOR A FLOW REACTOR AND METHOD FOR CATALYTIC OXIDATION OF AMMONIA

(71) Applicant: Heraeus Deutschland GmbH & Co. KG, Hanau (DE)

(72) Inventors: Jens HESSE, Hanau (DE); Pascal HIRSCHEL, Hanau (DE); Dirk MAIER, Hanau (DE); Uwe JANTSCH, Hanau (DE)

(21) Appl. No.: 18/319,907

(22) Filed: May 18, 2023

(30) Foreign Application Priority Data
May 25, 2022 (EP) 22175270.2

(51) Int. Cl. B01J 35/00; B01J 23/42; B01J 23/44; B01J 23/46; C01B 21/082

(52) U.S. Cl. CPC B01J 35/0006; B01J 23/42; B01J 23/44; B01J 23/464; B01J 35/0066; C01B 21/082

(57) ABSTRACT

The present invention relates to a catalyst system for flow reactors which is characterized by the sequence of the noble metal-containing alloys used of the catalyst networks forming the catalyst system. By using palladium alloys for a second and third catalyst network group, the platinum content of the catalyst system can be kept relatively low overall. In addition, the invention relates to a method for catalytic combustion of ammonia, in which a fresh gas containing at least ammonia is conducted through a catalyst system.

### CROSS-REFERENCE TO RELATED APPLICATIONS

This application claims priority pursuant to 35 U.S.C. 119(a) to European Application No. 22175270.2, filed May 25, 2022, which application is incorporated herein by reference in its entirety.

### FIELD

The present invention relates to a catalyst system for flow reactors which is characterized by the sequence of the noble metal-containing alloys used of the catalyst networks forming the catalyst system. In addition, the invention relates to a method for catalytic combustion of ammonia, in which a fresh gas containing at least ammonia is conducted through a catalyst system.

### BACKGROUND

Catalyst systems in the sense of the present invention are used in particular for gas reactions. They are used, for example, in the preparation of hydrocyanic acid by the Andrussow process or in the preparation of nitric acid by the Ostwald process. In order to provide a large catalytically active surface for these reactions, such catalysts generally comprise a spatial, gas-permeable structure. Collecting systems for recovering evaporated catalytically active components are also frequently based on such lattice structures. Usually, a plurality of networks are expediently arranged one behind the other and combined to form a catalyst system. The catalyst networks usually consist of single-layer or multi-layer knitted fabrics, braided fabrics, or woven fabrics. The individual networks consist of fine noble metal wires which predominantly contain platinum (Pt), palladium (Pd), rhodium (Rh) or alloys of these metals. In particular, capture networks may also contain further constituents, for example nickel.

Depending on the design, systems having 2 to 50 catalyst networks with a diameter of up to 6 meters are used in flow reactors. The use of noble metal represents a high, committed investment and is kept as low as possible. On the other hand, the “catalytic efficiency,” which is an important parameter and a measure of continuously high conversions of the reactants and good yield, depends on the noble metal content. Due to increasing noble metal prices and the resulting capital investment tied up in the catalyst systems, the aim is to minimize the noble metal content of the catalyst systems while maintaining efficiency.

During operation, the catalyst networks continuously lose noble metal due to oxidation and sublimation, and therefore they have to be replaced from time to time (endurance, service life) with a certain outlay. The PtRh5 alloy, which has become established as an industrial standard for noble metal catalysts for use in medium-pressure systems, has proven to be a suitable compromise with regard to service life, catalytic efficiency and noble metal use.

EP 3680015 A1 discloses catalyst systems composed of at least two network layers, in which binary PtRh alloys are preferably used of which the rhodium content decreases in the flow direction. The platinum content of the catalyst systems is overall high due to the use of platinum alloys.

In order to reduce the noble metal use while maintaining the catalytic efficiency, EP 1284927 A1 proposes a catalyst system consisting of at least two network layers, in which the first network, as seen in the flow direction, is formed from a platinum rhodium alloy and the second network is formed from a palladium rhodium alloy.

CN 101554585 A describes a catalyst system comprising at least three network layers made of alloys having different compositions. The platinum alloy of the middle network layer contains a high platinum content of 50-73 wt. %.

### SUMMARY

It was an object of the present invention to provide a catalyst system for a flow reactor in which the noble metal employed can be used with maximum efficiency.

In addition, the object of the invention was to specify a method for the use of such a catalyst system.

The object is achieved by a catalyst system for a flow reactor, comprising at least three catalyst network groups arranged one behind the other in the flow direction, each catalyst network group being formed from at least one catalyst network composed of at least one noble metal wire in each case, and
the first catalyst network group comprising at least one catalyst network composed of at least one first noble metal wire made of a platinum alloy, the platinum alloy consisting of, in addition to impurities, 80-98 wt. % platinum, 2-20 wt. % rhodium and 0-20 wt. % palladium,
the second catalyst network group comprising at least one catalyst network composed of at least one second noble metal wire made of a palladium alloy, the palladium alloy of the second noble metal wire consisting of, in addition to impurities, 70-97 wt. % palladium, 0-10 wt. % rhodium and 3-30 wt. % of at least one further metal, the at least one further metal being selected from the group consisting of nickel, tungsten, platinum and gold, and
the third catalyst network group comprising at least one catalyst network composed of at least one third noble metal wire made of a palladium alloy, the palladium alloy of the third noble metal wire consisting of, in addition to impurities, 72-97 wt. % palladium, 0-10% wt. % rhodium and 3-28 wt. % of at least one further metal, the at least one further metal being selected from the group consisting of nickel, tungsten, platinum and gold

characterized in that the rhodium content of the noble metal wires of the catalyst network groups decreases or remains constant in the flow direction and the palladium content of the noble metal wires of the catalyst network groups increases in the flow direction.

By using palladium alloys for the second and the third catalyst network group, the platinum content of the catalyst system can be kept relatively low overall. Within the scope of the invention, it has been found that, surprisingly, the positioning of catalyst networks with different compositions in the rear region of the catalyst system as seen in the flow direction has a significant influence on the efficiency of the system.

The present invention relates to a catalyst system for a flow reactor. In flow reactors, catalysts in the form of gas-permeable fabrics are typically incorporated into the reaction zone in a plane perpendicular to the flow direction of the fresh gas. Such gas-permeable fabrics are usually employed in the form of catalyst networks. A catalyst system is understood to mean an assembly of such catalyst networks.

The catalyst system according to the present invention comprises at least three catalyst network groups arranged one behind the other in the flow direction. Each catalyst network group is formed from at least one catalyst network composed of at least one noble metal wire in each case. A catalyst network group is understood to mean an assembly of at least one catalyst network in which the composition of the noble metal wires does not differ. Typically, a catalyst network group comprises more than one catalyst network. A catalyst system according to the invention thus comprises at least three catalyst networks composed of noble metal wires having three different compositions.

In the flow direction, the reacting gases first pass through the first, then the second and finally the third catalyst network group.

A catalyst network is understood to mean a single-layer or multi-layer gas-permeable fabric. The surface formation of the catalyst networks can be achieved by interlocking one or more noble metal wires to form a mesh. Catalyst networks can be produced, for example, by weaving, braiding or knitting a noble metal wire or a plurality of noble metal wires. The structure of the catalyst networks can thereby be set in a targeted manner by the use of different weaving, braiding or knitting patterns and/or different mesh sizes.

The catalyst network or catalyst networks of the first catalyst network group, the catalyst network or catalyst networks of the second catalyst network group and the catalyst network or catalyst networks of the third catalyst network group can be braided, woven and/or knitted independently of one another. Thus, braided, woven and knitted catalyst networks can be combined with one another as desired. For example, the catalyst network or catalyst networks of the first catalyst network group may be braided and the catalyst network or catalyst networks of the second and the third catalyst network group may be knitted. Likewise, the catalyst network or catalyst networks of the first catalyst network group may be knitted, the catalyst network or catalyst networks of the second knitted, and the catalyst network or catalyst networks of the third catalyst network group woven.

The catalyst network or catalyst networks of the first catalyst network group comprise a first weaving, braiding or knitting pattern and a first mesh size. The catalyst network or catalyst networks of the second catalyst network group comprise a second weaving, braiding or knitting pattern and a second mesh size, and catalyst network or catalyst networks of the third catalyst network group comprise a third weaving, braiding or knitting pattern and a third mesh size.

It has proven advantageous if at least two of the first, second and third weaving, braiding or knitting patterns are the same; particularly advantageously, the first, second and third weaving, braiding or knitting patterns are all the same.

Furthermore, it can be advantageous if at least two of the first, second and third mesh sizes are the same; particularly advantageously, the first, second and third mesh sizes are all the same.

The mass per unit area of the catalyst networks is not further limited. The mass per unit area of the catalyst networks can be in the range from 100 to 950 g/m², in particular in the range from 150 to 800 g/m². The masses per unit area of the catalyst networks within one of the at least three catalyst network groups can be the same or different. It has proven advantageous if the catalyst networks of a catalyst network group have the same mass per unit area.

The masses per unit area of the catalyst networks of the at least three catalyst network groups can remain equal, decrease or increase in the flow direction.

In preferred embodiments, at least one of the catalyst networks can comprise a three-dimensional structure. In the context of this application, networks are understood as flat, two-dimensional objects. A three-dimensional structure is understood to mean that the catalyst network also comprises, in addition to its planar extension, an extension into the third spatial dimension. Catalyst networks having a three-dimensional structure comprise a larger surface area, which advantageously affects the catalytic effectiveness and can reduce the pressure drop in the flow reactor. A three-dimensional structure can be obtained by using at least one noble metal wire having a two- or three-dimensional structure or by texturing the catalyst network. Three-dimensional structures of the catalyst network may be, for example, wave-shaped or coil-shaped. To produce such structures, an initially planar catalyst network may be subjected to a process step in which a three-dimensional structure is embossed or produced by folding.

Three-dimensional structures may be obtained by placing a planar catalyst network on a rigid, permeable, but non-planar surface, for example a preformed metal network. The structure of such a textured, permeable surface, which does not have to be catalytically effective, is then transferred to the catalyst network. Catalyst networks having such structures are also referred to as corrugated.

It has proven advantageous if at least one catalyst network of the catalyst system according to the invention comprises a three-dimensional structure, in particular if the catalyst network is a corrugated catalyst network. It may be advantageous if at least one catalyst network of each catalyst network group comprises a three-dimensional structure.

The number of catalyst networks used depends on the conditions in which the flow reactor is operated. Among other things, the throughput of fresh gas, which depends inter alia on the pressure, is a critical factor. For example, in a flow reactor operated at low pressure, e.g., up to about 5 bar abs., typically less than 15, often between 5 and 10 catalyst networks may be used, while at higher pressure, e.g., up to 15 bar, a larger number of catalyst networks, typically more than 20, often between 30 and 50 may be used.

The catalyst networks are formed from at least one noble metal wire in each case. The noble metal is preferably selected from the group consisting of the platinum metals, gold and silver. Platinum metals are understood to mean the metals of the so-called platinum group, i.e., platinum (Pt), palladium (Pd), iridium (Ir), rhodium (Rh), osmium (Os) and ruthenium (Ru). A noble metal wire is understood to be a wire consisting of noble metal or a noble metal alloy.

Preferably, noble metal wires are used which comprise a diameter of 40-250 μm, preferably 50-200 μm, particularly preferably 60-150 μm.

The noble metal wires can be designed as round wire, i.e., with a round cross section. In another embodiment, at least one of the noble metal wires can be designed as a flattened round wire or as a wire with a different cross section.

The noble metal wires may comprise a plurality of wires, in this case also referred to as filaments. The filaments may all consist of the same material, i.e., all containing noble metal, or consist of different materials, which in turn do not have to all contain noble metal.

The filaments may be twisted together; in these cases the noble metal wires comprise a rope-like structure.

The noble metal wires may comprise one or more helically formed longitudinal sections or may be formed over the entire length as a helically curved wire. If a noble metal wire comprises a helically formed longitudinal section, both the active catalyst surface of a catalyst network and the mass of the catalyst network relative to a surface unit may be adjusted, for example, via the wire thickness or via the number of turns of the helical longitudinal section. When such noble metal wires are used, the catalyst network produced therefrom can comprise a three-dimensional structure.

In many cases, it may be advantageous if a catalyst network is formed from two or more noble metal wires. In these cases, the noble metal wires may consist of the same material or of different materials. The plurality of noble metal wires may comprise the same or different diameters.

The first catalyst network group of the catalyst system according to the invention comprises at least one catalyst network composed of at least one first noble metal wire. The first noble metal wire comprises a platinum alloy which consists of, in addition to impurities, 80-98 wt. % platinum, 2-20 wt. % rhodium and 0-20 wt. % palladium.

A platinum alloy is understood to mean an alloy which consists of platinum to an extent of more than 50 wt. %. The fact that the alloy consists of 80-98 wt. % platinum means that the weight proportion of platinum makes up 80-98 wt. % of the weight of the total alloy. The platinum alloy of the first noble metal wire preferably contains 85-97 wt. % platinum, in particular 90-95 wt. %.

The noble metal alloys described herein may contain impurities. In the present case, an impurity is understood to mean an intended or unavoidable impurity caused by the production of the alloy or the alloys. Unless stated otherwise, the proportion of impurities in total is no more than 1 wt. % for all the noble metal alloys described, based on the total weight of the particular noble metal alloy, preferably no more than 0.5 wt. %. The noble metal alloys of the present application comprise in particular the platinum alloy of the first noble metal wire and the palladium alloys of the second and third noble metal wires.

In preferred embodiments, the platinum alloy of the first noble metal wire contains 3-18 wt. % rhodium, in particular 5-15 wt. %.

The platinum alloy of the first noble metal wire preferably contains no more than 15 wt. % palladium, in particular no more than 10 wt. %.

The platinum alloy of the first noble metal wire may contain impurities in addition to platinum, rhodium, and optionally palladium. The proportion of impurities in total is no more than 1 wt. % of the platinum alloy, preferably no more than 0.5 wt. %.

Particularly preferably, the first noble metal wire comprises a binary platinum alloy consisting of platinum and rhodium. The binary platinum alloy may also contain impurities as described above. In such cases, the platinum alloy of the first noble metal wire is, for example, PtRh3, PtRh5, PtRh8, PtRh10 or PtRh15. PtRh(X) here means that the alloy contains X wt. % rhodium and, apart from impurities, consists of (100−X) wt. % platinum.

In preferred embodiments, the first catalyst network group comprises 1 to 10 catalyst networks, preferably 3 to 8 catalyst networks. In particular, the first catalyst network group may comprise 1, 2, 3, 4, 5, 6, 7, 8, 9 or 10 catalyst networks.

Surprisingly, it has been found that it is sufficient for an adequate catalytic efficiency if the first catalyst network group comprises only one catalyst network. This represents a particularly simple and therefore preferred embodiment of the catalyst system.

The second catalyst network group of the catalyst system according to the invention comprises at least one catalyst network composed of at least one second noble metal wire composed of a palladium alloy. In addition to impurities, the palladium alloy of the second noble metal wire consists of 70-97 wt. % palladium, 0-10 wt. % rhodium and 3-30 wt. % of at least one further metal, wherein the at least one further metal is selected from the group consisting of nickel, tungsten, platinum and gold.

A palladium alloy is understood to mean an alloy which consists of palladium to an extent of more than 50 wt. %. The palladium alloy of the second noble metal wire preferably comprises a palladium content in the range of 75-95 wt. %, preferably of 80-90 wt. %.

The palladium alloy of the second noble metal wire may contain impurities in addition to palladium, nickel, tungsten, platinum or gold and optionally rhodium. The proportion of impurities in total is no more than 1 wt. % of the palladium alloy of the second noble metal wire, preferably no more than 0.5 wt. %.

The palladium alloy of the second noble metal wire preferably contains the at least one further metal in the range of 5-28 wt. %, particularly preferably in the range of 8-25 wt. %.

The palladium alloy of the second noble metal wire may contain any combination from the group consisting of nickel, tungsten, platinum and gold.

In preferred embodiments, the palladium alloy of the second noble metal wire comprises a rhodium content of 1-10 wt. %, in particular in the range of 3-8 wt. %. With regard to high catalytic efficiency with simultaneously low or no negative effects on service life, it may be advantageous for the palladium alloy of the second noble metal wire to contain at least 1.5 wt. % rhodium. In such cases, the second noble metal wire particularly preferably comprises a platinum content of at least 1.5 wt. %.

The second noble metal wire may comprise a ternary palladium alloy consisting of palladium, platinum and rhodium, or a binary palladium alloy that contains nickel, tungsten, platinum, or gold in addition to palladium. The binary or ternary palladium alloy may also contain impurities as described above.

The palladium alloy of the second noble metal wire may be PdPt10Rh5, PdPt15Rh3, PdPt20Rh1, PdNi5, PdW5, PdPt5, PdAu5, PdNi3, PdW3, PdPt3 or PdAu3, for example. PdPt(Z)Rh(X) herein means that the alloy contains Z wt. % platinum, X wt. % rhodium and, apart from impurities, consists of (100−(Z+X)) wt. % of palladium.

In preferred embodiments, the second catalyst group comprises 1 to 10 catalyst networks, preferably 3 to 8. In particular, the second catalyst network group may comprise 1, 2, 3, 4, 5, 6, 7, 8, 9 or 10 catalyst networks. The second catalyst network group preferably comprises more catalyst networks than the first catalyst network group.

The third catalyst network group of the catalyst system according to the invention comprises at least one catalyst network composed of at least one third noble metal wire made of a palladium alloy.

In addition to impurities, the palladium alloy of the third noble metal wire consists of 72-97 wt. % palladium, 0-10% wt. % rhodium and 3-28 wt. % of at least one further metal, wherein the at least one further metal is selected from the group consisting of nickel, tungsten, platinum and gold.

The palladium alloy of the third noble metal wire preferably comprises a palladium content in the range of 75-95 wt. %, particularly preferably in the range of 78-90 wt. %.

The palladium alloy of the third noble metal wire preferably contains the at least one further metal in the range of 5-25 wt. %, particularly preferably in the range of 8-20 wt. %.

The palladium alloy of the third noble metal wire may contain any combination from the group consisting of nickel, tungsten, platinum and gold.

The palladium alloy of the third noble metal wire may contain impurities in addition to palladium, nickel, tungsten, platinum or gold and optionally rhodium. The proportion of impurities in total is no more than 1 wt. % of the palladium alloy of the third noble metal wire, preferably no more than 0.5 wt. %.

According to the invention, the palladium content of the noble metal wires of the catalyst network groups increases in the flow direction. This increase in the palladium content has proven to be particularly advantageous for the catalytic efficiency of the catalyst system. The palladium content of the third noble metal wire is preferably above the palladium content of the second noble metal wire by at least 2 weight percentage points, in particular by 4 weight percentage points, more preferably by at least 8 weight percentage points.

According to the invention, the rhodium content of the noble metal wires of the catalyst network groups decreases or remains the same. Catalyst systems with such a rhodium gradient have surprisingly been found to be more efficient than systems in which one or more catalyst networks comprising a noble metal wire made of an alloy having a higher rhodium content are arranged in the rear or rearmost region of the catalyst system.

In preferred embodiments, the rhodium content of the third noble metal wire is below the rhodium content of the second noble metal wire by at least 2 weight percentage points, particularly preferably by at least 3 weight percentage points.

It may be preferred that the third noble metal wire does not contain rhodium. In these cases, the palladium alloy of the third noble metal wire is preferably a binary alloy, i.e., it consists of, in addition to impurities, palladium and only one further component. The further component is preferably platinum or nickel.

It may be advantageous if the third noble metal wire is platinum-free. In such embodiments, the platinum content in the catalyst system may be further reduced. Particularly preferably, in such cases, the third noble metal wire comprises a binary palladium alloy consisting of palladium and nickel, tungsten or gold.

Examples of preferred palladium alloy of the third noble metal wire include PdPt5Rh5, PdPt15Rh3, PdPt20Rh1, PdNi5, PdW5, PdPt5, PdAu5, PdNi3, PdW3 and PdAu3.

In preferred embodiments, the third catalyst network group comprises 1 to 10 catalyst networks, preferably 2 to 8. In particular, the third catalyst network group may comprise 1, 2, 3, 4, 5, 6, 7, 8, 9 or 10 catalyst networks. The third catalyst network group preferably comprises more catalyst networks than the first or second catalyst network group.

As a rule, the largest proportion of the total volume of the catalyst system of, for example, at least 70% is accounted for by the catalyst networks of the second and third catalyst groups and it is sufficient if only a small volumetric proportion of, for example, less than 30%, preferably less than 25%, and particularly preferably less than 20%, is accounted for by catalyst networks of the first catalyst network group composed of the rhodium-rich noble metal wire. The volume of the catalyst system or of the catalyst network groups is determined primarily by the number of catalyst networks used in each case.

It may be advantageous that both the second and the third noble metal wire are platinum-free. In such cases, the catalyst system comprises a particularly low platinum content.

In preferred embodiments of the catalyst system according to the invention,
the first noble metal wire is made of a binary platinum alloy consisting of platinum and rhodium,
the second noble metal wire is made of a ternary palladium alloy consisting of palladium, platinum and rhodium, and
the third noble metal wire is made of a binary palladium alloy consisting of palladium and nickel, tungsten, platinum or gold.

In particular, the first noble metal wire may consist of a PtRh(2-20) alloy, the second noble metal wire of a PdPt(3-30)Rh(1-10) alloy, and the third noble metal wire of a PdNi(3-30) alloy, a PdW(3-30) alloy, a PdPt(3-30) alloy, or a PdAu(3-30) alloy. PtRh(a-b) here means, for example, that the alloy contains rhodium comprising a weight proportion in the range from a to b wt. %, and the remaining proportion of the (100−(a to b)) wt. %, apart from impurities, consists of platinum.

It may also be preferred that
the first noble metal wire is made of a binary platinum alloy consisting of platinum and rhodium,
the second noble metal wire is made of a ternary palladium alloy consisting of palladium, platinum and rhodium, and
the third noble metal wire is made of a ternary palladium alloy consisting of palladium, platinum and rhodium.

In particular, the first noble metal wire may consist of a PtRh(2-20) alloy, the second noble metal wire of a PdPt(3-30)Rh(1-10) alloy, and the third noble metal wire of a PdPt(3-30)Rh(1-10) alloy.

In a further preferred embodiment,
the first noble metal wire is made of a binary platinum alloy consisting of platinum and rhodium,
the second noble metal wire is made of a binary palladium alloy consisting of palladium and nickel, tungsten, platinum or gold, and
the third noble metal wire is made of a binary palladium alloy consisting of palladium and nickel, tungsten, platinum or gold.

In particular, the first noble metal wire may consist of a PtRh(2-20) alloy, the second noble metal wire of a PdNi(3-30) alloy, a PdW(3-30) alloy, a PdPt(3-30) alloy, or a PdAu(3-30) alloy, and the third noble metal wire of a PdNi(3-30) alloy, a PdW(3-30) alloy, a PdPt(3-30) alloy, or a PdAu(3-30) alloy.

In further preferred embodiments of the catalyst system according to the invention,
the first noble metal wire is made of a ternary platinum alloy consisting of platinum, palladium and rhodium,
the second noble metal wire is made of a ternary palladium alloy consisting of palladium, platinum and rhodium, and
the third noble metal wire is made of a binary palladium alloy consisting of palladium and nickel, tungsten, platinum and gold.

In particular, the first noble metal wire may consist of a PtPd(1-20)Rh(2-10) alloy, the second noble metal wire of a PdPt(3-30)Rh(1-10) alloy, and the third noble metal wire of a PdNi(3-30) alloy, a PdW(3-30) alloy, a PdPt(3-30) alloy, or a PdAu(3-30) alloy.

The catalyst system may also comprise further components.

The catalyst system may comprise an ignition layer, for example, upstream of the first catalyst network group. An ignition layer comprises a noble metal wire which contains only platinum and impurities.

It may also be advantageous that at least the forwardmost catalyst network, as seen in the flow direction, contains a noble metal wire made of platinum, which contains no further components besides impurities. This front catalyst network may be a catalyst network of the first catalyst network group.

The catalyst system according to the invention may also comprise at least one further catalyst network group consisting of at least one catalyst network composed of at least one further noble metal wire.

The at least one further noble metal wire may comprise the same composition as the first, second or third noble metal wire, but the composition may also be different. In such cases too, it is preferred that the rhodium content of the noble metal wires decreases in the flow direction. In this case, the palladium content of the noble metal wires can remain equal, increase or decrease in the flow direction.

It has proven advantageous for the at least one further catalyst network group to be arranged upstream of the first catalyst network group. In such cases, it has been shown to be particularly advantageous if the at least one further noble metal wire comprises a platinum alloy, in particular a binary PtRh alloy.

The catalyst system according to the invention may contain, for example, at least four catalyst network groups, each comprising at least one catalyst network composed of at least one noble metal wire. The at least one further catalyst network group is preferably arranged upstream of the first catalyst network group. The rhodium content of the noble metal wires decreases in the flow direction or remains the same.

It may be preferred that
the at least one further noble metal wire comprises a binary platinum alloy consisting of platinum and rhodium,
the first noble metal wire comprises a binary platinum alloy consisting of platinum and rhodium,
the second noble metal wire comprises a ternary palladium alloy consisting of palladium, platinum and rhodium, and
the third noble metal wire comprises a binary palladium alloy consisting of palladium and nickel, tungsten, platinum or gold.

In particular, the first noble metal wire may consist of a PtRh(2-20) alloy, the second noble metal wire of a PdPt(3-30)Rh(1-10) alloy, the third noble metal wire of a PdNi(3-30) alloy, a PdW(3-30) alloy, a PdPt(3-30) alloy or a PdAu(3-30) alloy, and the at least one further noble metal wire of a PtRh(2-20) alloy.

It may also be preferred that
the at least one further noble metal wire comprises a binary platinum alloy consisting of platinum and rhodium,
the first noble metal wire is made of a binary platinum alloy consisting of platinum and rhodium,
the second noble metal wire is made of a ternary palladium alloy consisting of palladium, platinum and rhodium, and
the third noble metal wire is made of a ternary palladium alloy consisting of palladium, platinum and rhodium.

In particular, the first noble metal wire may consist of a PtRh(2-20) alloy, the second noble metal wire of a PdPt(3-30)Rh(1-10) alloy, the third noble metal wire of a PdPt(3-30)Rh(1-10) alloy, and the at least one further noble metal wire of a PtRh(2-20) alloy.

In a further preferred embodiment,
the at least one further noble metal wire is made of a binary platinum alloy consisting of platinum and rhodium,
the first noble metal wire is made of a binary platinum alloy consisting of platinum and rhodium,
the second noble metal wire is made of a binary palladium alloy consisting of palladium and nickel, tungsten, platinum, or gold, and
the third noble metal wire is made of a binary palladium alloy consisting of palladium and nickel, tungsten, platinum, or gold.

In particular, the first noble metal wire may consist of a PtRh(2-20) alloy, the second noble metal wire of a PdNi(3-30) alloy, a PdW(3-30) alloy, a PdPt(3-30) alloy, or a PdAu(3-30) alloy, the third noble metal wire of a PdNi(3-30) alloy, a PdW(3-30) alloy, a PdPt(3-30) alloy, or a PdAu(3-30) alloy, and the at least one further noble metal wire of a PtRh(2-20) alloy.

In a preferred embodiment, the catalyst system according to the invention may comprise at least one separating element between two of the catalyst network groups, for example in the form of at least one intermediate network. Such intermediate networks may be used to counteract a compression of adjacent catalyst network groups under pressure load. The intermediate network or the intermediate networks preferably has/have flexibility that is limited compared to the catalyst networks of the catalyst network groups.

Suitable separating elements are, for example, elements or networks made of a heat-resistant steel, typically a FeCrAl alloy such as Megapyr or Kanthal, stainless steel or of heat-resistant alloys, such as nickel-chromium alloys. The separating element or elements may also comprise a catalytically active coating comprising at least one noble metal.

It has proven advantageous if a separating element, in particular an intermediate network, is arranged between the first catalyst network group and the second catalyst network group. Intermediate networks made of Megapyr or Kanthal have proven to be particularly advantageous.

Separation elements in the form of intermediate networks may also be arranged within the catalyst network groups.

The catalyst system according to the invention is suitable for the preparation of nitric acid by the Ostwald process. An ammonia-oxygen mixture flows through the catalyst system; in other words, this relates to a catalytic ammonia combustion.

The catalyst system according to the invention is also suitable for preparing hydrocyanic acid by the Andrussow process. An ammonia-methane-oxygen mixture flows through the catalyst system.

The present invention also relates to a method for catalytic oxidation of ammonia, in which a fresh gas containing at least ammonia is conducted through the catalyst system according to the invention. For preferred embodiments of the catalyst system, reference is made to the preceding statements.

The ammonia content of the fresh gas is preferably between 9.5 and 12% by volume.

The pressure of the fresh gas is preferably between 1 and 14 bar, in particular between 3 and 10 bar. The catalyst network temperature is preferably in the range from 500 to 1300° C., preferably in the range from 800 to 1100° C.

Preferably, the fresh gas is conducted through a catalyst system according to the invention at a throughput in the range from 6 to 60 tN/m² d. The abbreviation “tN/m² d” stands for “tons of nitrogen (from ammonia) per day and a standardized effective cross-sectional area of the catalyst system of one square meter.

The invention is explained below with reference to a drawing and exemplary embodiments and an experiment on catalytic activity.

### DETAILED DESCRIPTION

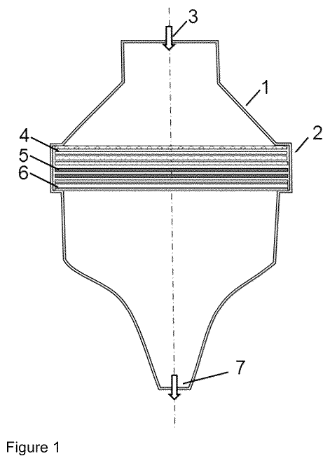

FIG. 1 schematically shows a vertically positioned flow reactor 1 for heterogeneously catalytic combustion of ammonia. The catalyst system 2 forms the actual reaction zone of the flow reactor 1. The catalyst system 2 comprises a plurality of catalyst network groups (4, 5, 6) arranged one behind the other in the flow direction 3 of the fresh gas.

The fresh gas is an ammonia-air mixture comprising a nominal ammonia content of 10.7% by volume. It is heated to a preheating temperature of 175° C. and introduced from above into the reactor 1 at an elevated pressure of 5 bar. Upon entry into the catalyst system 2, the gas mixture is ignited and a subsequent exothermic combustion reaction takes place. The following main reaction takes place:

4NH₃+5O₂→4NO+6H₂O

In this case, ammonia (NH₃) is converted to nitrogen monoxide (NO) and water (H₂O). The nitrogen monoxide (NO) formed reacts in the outflowing reaction gas mixture (symbolized by the directional arrow 7 indicating the flow direction of the outflowing reaction gas mixture) with excess oxygen to form nitrogen dioxide (NO₂), which is added to water in a downstream absorption system to form nitric acid (HNO₃).

The catalyst networks are in each case textile fabrics which are produced from the relevant noble metal alloy by machine braiding a noble metal wire with a diameter of typically 76 μm. In Tables 1 and 2, exemplary embodiments (E1-E11) for catalyst systems are specified which can be used in a flow reactor 1.

TABLE 1

| | E1 | E2 | E3 | E4 | E5 | E6 |
|---|---|---|---|---|---|---|
| [symbol] 1 | PtRh5 | PtRh5 | PtRh5 | PtRh5 | PtRh5 | PtRh5 |
| [symbol] 2 | PdPt15Rh3 | PdPt15Rh3 | PdPt10Rh3 | PdPt15Rh3 | PdPt15 | PdPt20Rh1 |
| [symbol] 3 | PdPt5 | PdNi5 | PdNi5 | PdNi5 | PdNi5 | PdNi5 |

[symbol]

indicates data missing or illegible when filed

TABLE 2

| | E7 | E8 | E9 | E10 | E11 |
|---|---|---|---|---|---|
| G1 | PtRh5 | PtRh5Pd5 | PtRh5Pd5 | PtPd15Rh5 | PtPd15Rh5 |
| G2 | PdPt10Rh1 | PdPt20 | PdPt10Rh5 | PdPt10Rh5 | PdPt5Rh5 |
| G3 | PdW5 | PdNi5 | PdPt5Rh5 | PdPt5 | PdW5 |

The catalyst systems each comprise 3 catalyst network groups with a total of 30 catalyst networks; the sequence of the naming G1 to G3 reflects the arrangement in the flow direction of the fresh gas.

Table 3 indicates the composition of a catalyst system E12 with 4 catalyst network groups in which a rhodium-richer group G0 is arranged upstream of the catalyst system according to the invention with G1-G3.

TABLE 3

| | E12 |
|---|---|
| G0 | PtRh8 |
| G1 | PtRh5 |
| G2 | PdPt15Rh3 |
| G3 | PdNi5 |

In a test reactor according to FIG. 1, the catalyst systems E1-E12 were compared to catalyst systems in which the arrangement of the catalyst network groups G2 and G3 was reversed. In the comparative reactors, the catalyst network group with the rhodium-rich alloy was thus behind the rhodium-poorer alloy. Both reactors each have the same content of catalytically active noble metal.

The test reactors were operated under the following identical test conditions in each case.
Pressure: 5 bar (absolute)
Throughput: 12 tons of nitrogen (from ammonia) per day and effective cross-sectional area of the catalyst packing in square meters (abbreviated to 12 tN/m²d)
NH₃ proportion: 10.7% by volume in the fresh gas
Preheating temp.: 175° C. (NH 3 temperature/air mixture), resulting in a network temperature of 890° C.

At an interval of about 12 h, over a period of 4 days, the development of the catalyst efficiency of the catalyst (yield of NO in %) and the amount of nitrous oxide N₂O occurring as an undesired by-product was measured.

The measurement of the catalytic efficiency (i.e., the product yield of NO) has the following sequence:
1. It is ensured that the catalyst system is suitable for the complete conversion of the ammonia used. That means that NH₃ in the product gas is no longer present in a significant amount, which is checked by means of mass spectrometric analysis of the product gas.
2. Simultaneous removal of a sample of NH₃/air upstream of the catalyst packing and a sample from the product gas downstream in respectively independent evacuated pistons. The mass of the gas is determined by weighing.
3. The NH₃/air mixture is absorbed in distilled water and titrated by means of 0.1 N sulfuric acid and methyl red after color change.
4. The nitrous product gases are absorbed in 3% sodium peroxide solution and titrated by means of 0.1 N sodium hydroxide solution and methyl red after color change.
5. The catalytic efficiency Eta results from: Eta=100×Cₙ/Cₐ, where Cₐ is the average NH₃ concentration of 7 individual measurements in the fresh gas in percent by weight and Cₙ is the mean NOₓ concentration of 7 individual measurements expressed as percent by weight of the NH₃ which has been oxidized to form NOₓ.
6. Separately, the volumetric proportion of N₂O in the product gas is determined by means of gas chromatography.

In the reactors equipped according to the invention, it was possible to observe an efficiency increased over the entire test period by an average of 0.4% with a comparable proportion of N₂O. In this field of technology, the increase by 0.4% represents a significant and economically significant enhancement.

What is claimed is:

1. A catalyst system for a flow reactor, comprising at least three catalyst network groups arranged one behind the other in the flow direction,
each catalyst network group being formed from at least one catalyst network composed of at least one noble metal wire in each case, and
the first catalyst network group comprising at least one catalyst network composed of at least one first noble metal wire made of a platinum alloy, the platinum alloy consisting of, in addition to impurities, 80-98 wt. % platinum, 2-20 wt. % rhodium and 0-20 wt. % palladium,
the second catalyst network group comprising at least one catalyst network composed of at least one second noble metal wire made of a palladium alloy, the palladium alloy of the second noble metal wire consisting of, in addition to impurities, 70-97 wt. % palladium, 0-10 wt. % rhodium and 3-30 wt. % of at least one further metal, the at least one further metal being selected from the group consisting of nickel, tungsten, platinum and gold, and
the third catalyst network group comprising at least one catalyst network composed of at least one third noble metal wire made of a palladium alloy, the palladium alloy of the third noble metal wire consisting of, in addition to impurities, 72-97 wt. % palladium, 0-wt. % rhodium and 3-28 wt. % of at least one further metal, the at least one further metal being selected from the group consisting of nickel, tungsten, platinum and gold
wherein
the rhodium content of the noble metal wires of the catalyst network groups decreases or remains constant in the flow direction, and
the palladium content of the noble metal wires of the catalyst network groups increases in the flow direction.

2. The catalyst system according to claim 1, wherein the catalyst networks are woven, braided or knitted independently of one another.

3. The catalyst system according to claim 1, wherein at least one of the catalyst networks comprises a three-dimensional structure.

4. The catalyst system according to claim 3, wherein at least one of the catalyst networks is corrugated.

5. The catalyst system according to claim 1, wherein the noble metal wires comprise a diameter of 40-250 μm.

6. The catalyst system according to claim 1, wherein the first noble metal wire comprises a binary platinum alloy which consists of, in addition to impurities, platinum and rhodium.

7. The catalyst system according to claim 1, wherein the second noble metal wire comprises a ternary palladium alloy which consists of, in addition to impurities, palladium, platinum and rhodium, or comprises a binary palladium alloy, which consists of, in addition to impurities, palladium and nickel, tungsten, platinum or gold.

8. The catalyst system according to claim 1, wherein the palladium content of the third noble metal wire is above the palladium content of the second noble metal wire by at least 2 weight percentage points.

9. The catalyst system according to claim 1, wherein the rhodium content of the third noble metal wire is below the rhodium content of the second noble metal wire by at least 2 weight percentage points.

10. The catalyst system according to claim 1, wherein the third noble metal wire comprises a binary palladium alloy, which consists of, in addition to impurities, palladium and nickel, tungsten, platinum or gold.

11. The catalyst system according to claim 1, wherein the third noble metal wire is platinum-free.

12. The catalyst system according to claim 1, wherein the third noble metal wire is rhodium-free.

13. The catalyst system according to claim 1, wherein the catalyst system comprises at least one further catalyst network group composed of at least one catalyst network composed of at least one further noble metal wire.

14. The catalyst system according to claim 1, wherein the catalyst system comprises at least one separating element between two of the catalyst network groups.

15. A method for catalytic oxidation of ammonia, wherein a fresh gas containing at least ammonia is conducted through a catalyst system according to claim 1.
